(19) United States
(12) Patent Application Publication
(10) Pub. No.: US 2007/0154007 A1
(43) Pub. Date: Jul. 5, 2007

(54) Method and device for agent-optimized operation of a call center

(76) Inventor: Michael Bernhard, Karlsruhe (DE)

Correspondence Address: WILLIAM COLLARD;COLLARD & ROE, P.C., 1077 NORTHERN BOULEVARD, ROSLYN, NY, 11576, US

(21) Appl. No.: 11/644,714

(22) Filed: Dec. 22, 2006

(30) Foreign Application Priority Data
Dec. 22, 2005 (DE) 10 2005 061 434.5

(51) Int. Cl. H04M 3/00; H04M 5/00

(52) U.S. Cl. 379/265.01

(57) ABSTRACT

Offers for the purchase of goods and for the conclusion of contracts are made in call centers to a plurality of customers. Aside from the goods, a successful business transaction depends on whether or not the customer is comfortable with the salesperson in question. The most ideal assignment of a call center agent to a customer is made possible by a suitable assignment of agent to customer by balancing acquired agent properties against determined or supplied customer characteristics.

### BACKGROUND OF THE INVENTION

1. Field of the Invention

The invention relates to a method and a device for agent-optimized operation of a call center by a control unit that automatically places outbound or receives inbound customer calls, using automated dialers. The control unit accesses a connected address database containing customer data sets, and, after a telephone connection has been established, selects a free agent in real time, and passes the call on to this agent.

2. The Prior Art Such a method is already known from German Patent No. 10 2005 036 905.7 A1. In this connection, a totality of customers is first made available within the framework of a telephone campaign, and called over the course of the campaign. This totality of customers is a customer base compiled according to various aspects, which base is either created in packets or purchased. Aside from the address data of the customer, such as the name and telephone number, other data are usually also stored in memory, which data can vary, depending on the data source. For example, it is easy to determine the gender, on the one hand, while the age of the person in question already represents valuable additional information. In order not to have to build up new data on a regular basis, call centers usually administer their customer bases, so that increasingly more information about the individual customers is collected over time. This information in turn leads to a more customer-specific selection of the offers made to the customer within the framework of the telephone campaigns.

Therefore, under some circumstances, it might be easier to sell jewelry, for example, to a woman, rather than technical equipment. In this connection, the likelihood of investing a greater amount of money in jewelry also increases with age, on the average, for example. By constant administration of the data sets and appropriate evaluations, the sales offers can be improved to the effect that a customer is not offered a completely non-typical product, so that the likelihood of a sale is increased.

However, it is known that the product alone is not the decisive factor for a successful sales conversation. It is also important to the customer that the person with whom they are speaking during the sales conversation appears likeable to them and is someone to inspire their confidence. While one agent of the call center possibly has a voice that is attractive to younger women, and can handle them well, middle-aged men might consider competent and assertive behavior to be more important. It can also be assumed that individual agents have various competences that in turn might be interpreted differently by different customer groups, and actually demanded or expected by them.

However, assigning a certain agent to a certain customer in fixed manner is not cost-effectively possible, because of the amount of incoming and outgoing calls in a call center.

### SUMMARY OF THE INVENTION

It is therefore an object of the invention to provide a method by means of which the most ideal possible assignment of a call center agent to a customer is made possible.

This object is accomplished by means of the method according to the invention, for agent-optimized operation of a call center. According to the invention, a call center has a pool of agents that is imaged in an agent database. An agent data set that contains characteristics is clearly assigned to each agent. The call center is centrally controlled by a control unit that initiates customer conversations according to a method of “predictive dialing,” for example. For this purpose, more customers are regularly called than there are agents available, since there will be no conversation with a certain proportion of the customers called. As soon as a communication connection has been established, an agent is then selected, in real time, whose combination of characteristics, as stored in his/her agent data set, corresponds with the customer characteristics in the best possible manner. Assignment in advance is not possible, because first of all, the control unit cannot know when a certain agent will be free, and second of all, it does not know whether the conversation with the dialed customer will actually come about. A significant effect in balancing the customer data against the agent data is that an agent that matches the customer as precisely as possible is found. This is furthermore supported by the fact that the system is self-learning, in other words the agent data set is adapted, preferably automatically, after the conversation, taking into consideration the result of the conversation and the customer characteristics.

This adaptation is possible because the customer data sets are divided into clusters. In this connection, each cluster stands for a customer characteristic, for example. Because only the cluster(s) that is/are significant for the customer is/are activated when selecting the agent, a search with a focus on specific properties of an agent that are imaged in the corresponding clusters is made possible. The selection of an agent takes place according to the quality value q to be calculated by the control unit.

In keeping with reality, it is not always possible to select only the qualitatively best agent for a customer, in each instance, but rather a plurality of the N best agents is compiled in a list, in the order of descending quality value in the activated clusters. It would not be sufficient to find only the best agent if the latter is busy with a conversation. Therefore the control unit runs through the list according to descending quality value q, and selects the first available agent.

In this connection, it calculates the quality value of each agent, which is determined from the individual quality values qᵢ and the activation strength yᵢ of the clusters in question, according to the formula

$$q = \frac{\sum {q}_{i} \cdot {y}_{i}}{\sum {y}_{i}}$$

The individual quality values qᵢ of the clusters in question, in each instance, can in turn be determined from the quotient of the number of successful sales conversations that relate to this cluster, and the total number of sales conversations conducted with regard to this cluster.

As soon as a sales conversation has been concluded, these data are updated again, so that the data sets are dynamic. An agent therefore does not necessarily remain “the same” when considered over time. He/she can improve or get worse, from case to case, in the list that is generated in customer-specific manner in real time.

An additional selection possibility for a control unit results from the additional parameters stored in the agent data sets. These parameters can be, for example, an activation or deactivation parameter, which can be used for a break taken by the agent in question, for example, so that no calls are passed to him/her during this time. Another possibility is to perform prioritization by way of such a parameter, resulting in preferred or disadvantaged treatment of the individual agent.

It is advantageous if information about the agent and about the customer reaction, for example a purchase or a rejection, is stored in the customer database after the sales conversation. These data later help to guarantee appropriately optimized consultation for the individual customer and, in particular, agent assignment.

Characteristics and additional customer data can also be kept available for the information of the individual agent, in the sales conversations, aside from the selection of the agent. Such data are, in particular, age, gender, the sales volume already achieved with this customer, sales according to categories, profession, and/or the number of persons living in the customer's household.

It is practical for follow-up, for statistics, and as the basis for “predictive dialing” to provide each database entry with a time stamp, so that later, durations and points in time of conversations can be evaluated or inspected. Aside from capacity utilization of the agents, an overview of the conversations held with the individual customer is also possible.

Agents newly joining a call center or a work group are given a new agent data set that is at first initialized with zero. This concerns, in particular, the success and activation counters for the individual clusters, and a general selection counter that documents the total frequency of the selection of the individual agent.

It can sometimes be advantageous if the clusters are also designed to be dynamic, so that in the case of a cluster that is hardly used, it is possible to combine clusters, and in the case of clusters that are used a lot, it is possible to divide them. There could be a case, for example, that a cluster relates to all the customers between the ages of 30 and 40. If utilization was low, it could be practical to create a cluster having customers between the ages of 25 and 45, by combining it with others. In the opposite case, a division into a cluster for customers between 30 and 35 and a cluster for customers between 35 and 40 would also be possible.

It has proven to be advantageous to pass the customer data sets onto a processing unit for evaluation, which unit draws conclusions concerning the acceptance of the individual products by specific customer groups. In this way, it can be determined to which customers a product should be offered, and which product should possibly be removed from the product line entirely.

On the basis of a customer data set passed on to the processing unit before the customer conversation, the unit can make suggestions for offerings to the customer in question. It is advantageous if these suggestions are displaced to the agent during his/her conversation, or passed on to him/her in some other manner.

The functionality of the processing unit can also be used to check whether or not a sales conversation is to be initiated with a certain customer at all. Of course, this would not make any sense if the product currently being offered does not correspond to the profile of the customer, or, vice versa, if no product that corresponds to the customer profile is available in the product line. This saves both telephone costs and agent labor.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a block diagram of the process of agent selection;

FIG. 2 shows a block diagram of an agent data set; and

FIG. 3 shows a block diagram of the method according to the invention.

### DETAILED DESCRIPTION OF THE PREFERRED EMBODIMENT

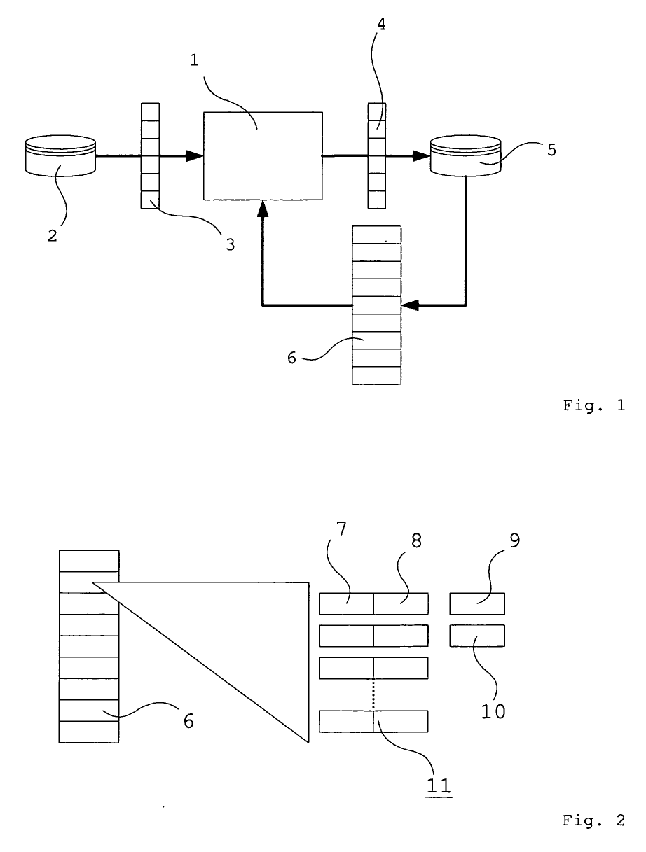

Referring now in detail to the drawings, FIG. 1 shows a control unit 1, which is connected, in terms of data, with a customer database 2 and an agent database 5. In order to conduct a sales conversation, a customer data set 3 is first selected from customer database 2, and made available to control unit 1. Customer data set 3 contains not only address data such as the name and the telephone number of the customer, but also a plurality of characteristics according to which the customer in question can be assigned to one or more clusters. In this connection, a cluster is represented by a feature vector w, which possesses the length 1 to maximally n, whereby a customer characteristic is clearly assigned to each vector component. In this connection, vector w represents a typical combination of characteristics of a customer group. Control unit 1 images the assignment of the customer to each individual cluster in an activation vector 4. Using this activation vector 4, agent database 5 is searched for an agent that matches the customer. The agent data sets stored in the memory of agent database 5 have characteristic counters for each cluster. On the basis of these characteristic counters, a quality value q can be calculated for each agent, for the given activation vector 5. The quality of an agent is calculated according to the formula

$$q = \frac{\sum {q}_{i} \cdot {y}_{i}}{\sum {y}_{i}}$$

In this connection, the yᵢ are the activation of the individual clusters for the customer having the characteristics x. The individual quality characteristics qᵢ are calculated by means of the formula

$$qi = \frac{\sum {y}_{ij} \cdot tj}{\sum {y}_{ij}}$$

over all j. yᵢⱼ is the activation of the cluster i during the customer conversation j, where the agent in question conducted this conversation. tⱼ is a number that metrically images the result of the corresponding customer conversation.

The N agents having the highest quality values q are compiled in an agent list 6, with descending quality values q. On its search for the suitable agent for the customer in question, control unit 1 goes through this agent list 6 in order of descending quality values q, and selects the first available agent.

FIG. 2 shows the structure of an agent data set, in detail, which set consists of a plurality of counter pairs 11, namely one for each cluster. Counter pairs 11 are each composed of a success counter 7 and an activation counter 8. The activation counter 8 is raised by the value of the assigned component in activation vector 4 after each customer conversation. The success counter 7 is increased by a value that results from the product of the value of the assigned component in activation vector 4 and the success measure of the conversation (0=no success, 1=greatest success). The quotient of counter 7 and counter 8 lead to a quality measure of an agent with regard to a cluster, which determine the selection of the agent, in each instance.

Furthermore, a parameter memory 10 and a selection counter 9 are provided in the individual agent data sets. Selection counter 9 counts the frequency of the selection of the agent, independent of the activated clusters. This is necessary since the total frequency can no longer be determined from the individual frequency of the clusters, due to the fact that several clusters were activated in a conversation. Parameter memory 10 contains parameters, for example for activation and/or deactivation of the agent or for setting prioritizations.

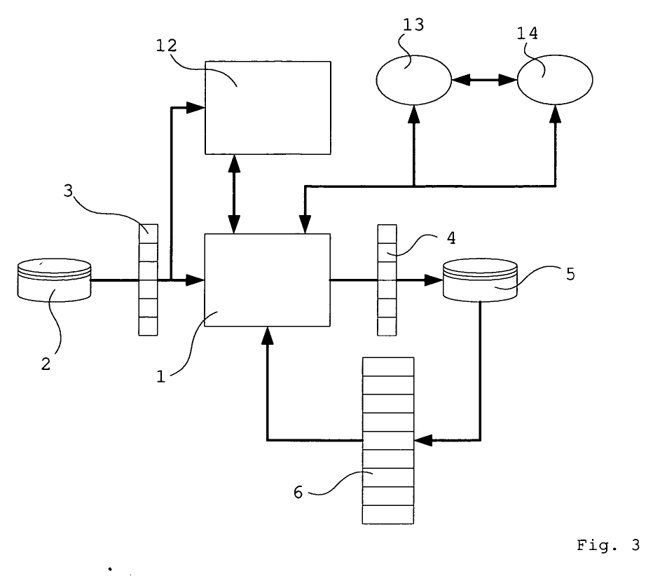

FIG. 3 illustrates the entire method, which proceeds as follows. In outbound operation, in other words when the customer conversation is initiated by control unit 1, the selected customer data set 3 is first passed to a processing unit 12, which makes a qualified suggestion for a product offering on the basis of the characteristics of the customer data set 3. If the processing unit 12 cannot make an offer, customer 14 is not even called. It will now be assumed that an offer is possible. Then customer 14 is contacted, and after the communication connection has been established according to the method described above, an agent 13 is selected. Customer 14 and agent 13 are connected with one another, while the product offering of processing device 12 is submitted to the agent 13, which he/she presents to customer 14. In our case, let the customer decide in favor of the purchase. After the conversation, control unit 1 will raise selection counter 9 of agent 13, because he/she was selected. Furthermore, activation counters 8 and success counters 7 will be raised for all of the activated clusters in the agent data set, since agent 13 was active with regard to these clusters and successfully utilized his/her properties determined by the clusters. In other words, he/she improved and is more likely to be selected in the next selection related to the clusters in question.

Furthermore, control unit 1 reports a sale of the product to processing unit 12, when returning the customer data set, so that processing unit 12 can adapt the potential customer group of the product in question.

Above, a method and a device for agent-optimized operation of a call center are therefore described, by means of which a suitable assignment of agents to customers is achieved by balancing acquired agent properties against determined or supplied customer characteristics.

Accordingly, while only a few embodiments of the present invention have been shown and described, it is obvious that many changes and modifications may be made thereunto without departing from the spirit and scope of the invention.

### REFERENCE SYMBOL LIST

1 control unit
2 customer database
3 customer data set
4 activation vector
5 agent database
6 agent list
7 success counter
8 activation counter
9 selection counter
10 parameter memory
11 counter pairs
12 processing unit
13 agent
14 customer

What is claimed is:

1. A method for agent-optimized operation of a call center by a control unit that automatically places outbound or receives inbound customer calls, using automated dialers, comprising:
accessing a connected customer database containing customer data sets with the control unit;
establishing a communication connection with a customer via a call;
selecting a free agent after said connection has been established, said selection taking place in real time using an agent database containing agent data sets so that characteristics of the customer data set of the customer correlate to a maximum extent with characteristics of the agent data set of the selected agent;
passing the call on to said agent.

2. A method according to claim 1, wherein the customer data sets are divided into clusters, and the control unit activates at least one cluster that most corresponds to the customer data set of the customer.

3. A method according to claim 2, wherein the control unit selects an agent data set that has a highest quality value q with regard to the selected clusters.

4. A method according to claim 2, wherein the agent data sets having N best quality values q are arranged in an agent list, by descending quality values q, and wherein the control unit runs through said agent list by descending quality values q, and selects the agent data set of the first available agent in real time, by means of a dialer.

5. A method according to claim 3, wherein the control unit determines the quality value q using the formula
$$q = \frac{\sum {q}_{i} \cdot {y}_{i}}{\sum {y}_{i}}$$
wherein qᵢ represents the quality of the agent with regard to the individual clusters i of interest, and yᵢ represents an activation intensity of this cluster i.

6. A method according to claim 5, wherein the control unit determines the quality value qᵢ for a cluster i by forming a quotient of a weighted sum of successful sales conversations and a weighted sum of an absolute number of sales conversations conducted.

7. A method according to claim 2, wherein the agent data sets are dynamic and a selection frequency for individual clusters, successfully conducted sales conversations with regard to individual clusters, and an absolute selection frequency of the agent are automatically updated in each agent data set.

8. A method according to claim 1, wherein additional parameters relating to activation or deactivation of the agent or prioritization, are assigned to the agent data sets.

9. A method according to claim 1, wherein data at least about the agent and about a customer reaction are added to the customer database after a sales conversation.

10. A method according to claim 9, wherein the customer data sets contain additional customer data selected from the group consisting of age, gender, sales volume, sales in different categories, profession and number of persons in household.

11. A method according to claim 1, wherein a time stamp is assigned to entries to the database.

12. A method according to claim 1, wherein new agent data sets are added to an agent database, and wherein success counters, activation counters or selection counters are set up in the agent data sets and initialized with zero.

13. A method according to one of claim 2, wherein the clusters are dynamic, and wherein individual clusters can be combined or divided, and a number of success counters and activation counters in the agent data sets is adapted accordingly.

14. A method according to claim 1, wherein after a customer conversation, the control unit passes the customer data sets, together with a reaction of the customer, on to a processing unit for evaluation.

15. A method according to claim 14, wherein the processing unit makes suggestions for an offer of products to the customer using the data collected, said suggestions being made based on a comparison of characteristics of the customer data set with characteristics of purchasers of individual products.

16. A method according to claim 15, wherein the control unit passes the suggestions on to the selected agent.

17. A method according to claim 15, wherein a customer conversation is initiated by the control unit only if the processing unit can make a product suggestion after checking the customer data set in question.

18. A device for agent-optimized operation of a call center, comprising:
a control unit for process control by means of which automatic customer calls are placed or received, using automatic dialers;
a customer database containing customer data sets, said customer database being accessible by the control unit; and
an agent database containing agent data sets for selection of an agent, such that a communication connection with a customer has been established, an available agent is selected from the agent database, and the communication connection can be passed through to said agent, and wherein characteristics of the customer data set of the customer correlate to a maximal extent with characteristics of the agent data set of the selected agent.
